(19) United States
(12) Patent Application Publication
(10) Pub. No.: US 2007/0037558 A1
(43) Pub. Date: Feb. 15, 2007

(54) Mobile communication devices, systems, and methods for dynamic update of map data

(75) Inventors: Hung-Chih Yu, Taipei County (TW); Huan-Wen Chien, Taipei County (TW)

Correspondence Address: BIRCH STEWART KOLASCH & BIRCH, PO BOX 747, FALLS CHURCH, VA, 22040-0747, US

(73) Assignee: GIGA-BYTE COMMUNICATIONS INC. and GIGA-BYTE TECHNOLOGY, LTD.

(21) Appl. No.: 11/318,453

(22) Filed: Dec. 28, 2005

(30) Foreign Application Priority Data
Aug. 10, 2005 (TW) 94127100

(51) Int. Cl. H04Q 7/38

(52) U.S. Cl. 455/414.1

(57) ABSTRACT

A mobile communication device comprises a communication unit and a processor. The communication unit initiates a wireless communication channel within a range. The processor coupled to the communication unit automatically determines if a server offering point of interest (POI) data exists in the range. If so, the communication unit initiates a wireless communication channel with the server and downloads the POI data therefrom.

### BACKGROUND

The invention relates to computer communication techniques, and in particular, to mobile communication devices, systems, and methods for dynamic update of map data.

An electronic map in a personal computer, a cell phone, or a personal digital assistant (PDA) is typically used for navigation. In addition to direction assistance, location-related information, such as points of interest (POI) is also desirable.

Current electronic maps could provide more POI data. Even if a large quantity of POI data is provided, it may not meet user requirements. For example, given that one hundred thousand POI data records are distributed among Taiwan plane areas, which form one fifth of the 35,873 km2 total territory, only 14 POI data records per one km2 are available.

### SUMMARY

Accordingly, mobile communication devices, systems, and methods for dynamic update of map data are provided.

An exemplary embodiment of a mobile communication device for dynamic update of points of interest comprises a communication unit and a processor coupled thereto. The communication unit is capable of wireless communication within a range. The processor automatically determines if a server offering points of interest (POI) data exists in the range, and, if so, initiates a wireless communication channel with the server utilizing the communication unit and downloads the POI data therefrom.

An exemplary embodiment of a mobile communication device for dynamic update of points of interest comprises a communication unit, a global positioning system (GPS) receiver, and a processor. The communication unit can initiate a wireless communication channel. Prior to transmitting a request for downloading POI data, the processor automatically retrieves coordinates of the mobile communication device from the GPS receiver, transmits the request comprising the coordinates through the wireless communication channel to a server, and downloads the POI data therefrom.

An exemplary embodiment of a system for dynamic update of POI data comprises a mobile communication device and a server. The mobile communication device comprising an electronic map initiates a wireless communication channel with the server. The server determines current position of the mobile communication device, locates data of points of interest (POI) based on the position, and transmits the POI data to the mobile communication device through the wireless communication channel. The mobile communication device receives and integrates the POI data into the electronic map.

### DESCRIPTION OF THE DRAWINGS

The invention can be more fully understood by reading the subsequent detailed description and examples with references made to the accompanying drawings, wherein:

FIG. 1 is a block diagram of an exemplary embodiment of a communication system;

FIG. 2 is a flowchart of an exemplary embodiment of dynamic POI data update; and

FIG. 3 is a schematic diagram of a communication range of a mobile communication device.

### DETAILED DESCRIPTION

Mobile communication devices, systems, and methods for dynamic update of map data are provided. Note that entities, steps, and configuration thereof described in the following are only examples and can be adjusted according to real requirements.

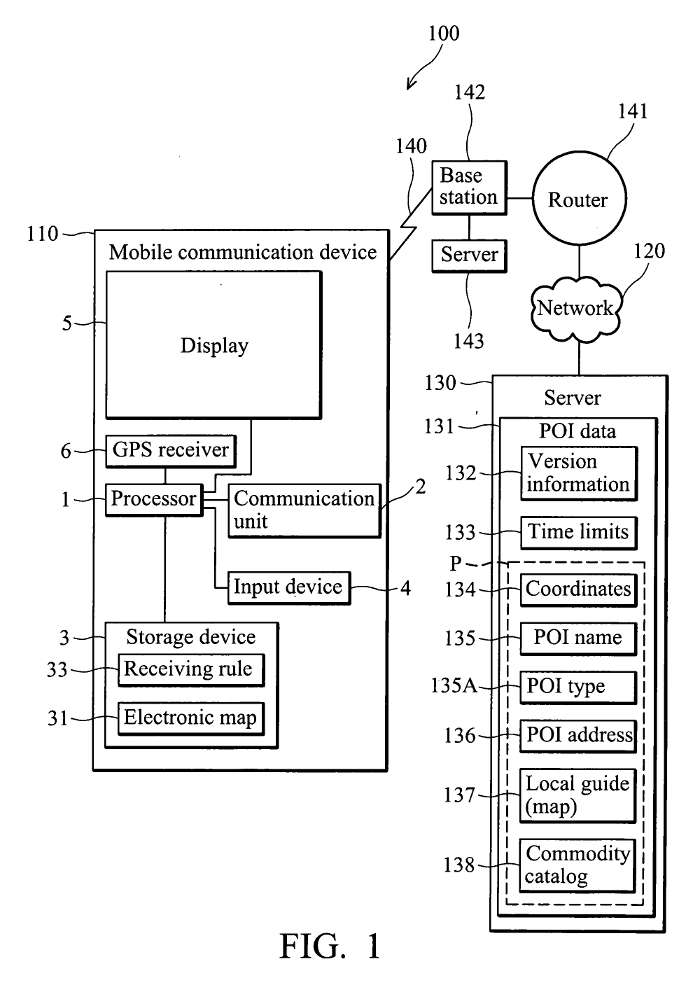

In communication system 100 of FIG. 1, network 120 may be a network provided by a telecommunication service provider, a local area network (LAN), or the Internet. Mobile communication device 110 and server 130 initiate wireless communication channel 140 through network 120. They may directly initiate wireless communication channel 140 without utilizing network 120. For example, wireless communication channel 120 may conform to the specification of wireless LAN, Bluetooth, global system for mobile communications (GSM), general packet radio service (GPRS), wideband code division multiple access (WCDMA), CDMA2000, or Wi-Fi.

Mobile communication device 110 is illustrated as a cell phone, but may alternatively comprise a personal digital assistant (PDA), a laptop, or a handheld device.

Mobile communication device 110 comprises a global positioning system (GPS) receiver 6 which may be an integral component. Mobile communication device 110, however, may externally connect to a GPS receiver or may not utilize any GPS receiver. Components of mobile communication device 110 comprise processor 1, communication unit 2, storage device 3, input device 4, display 5, and GPS receiver 6. Processor 1 is coupled to the other components. Storage device 3 comprises an electronic map 31 and receiving rule 33.

Communication system 100 executes a method for dynamic update of POI data.

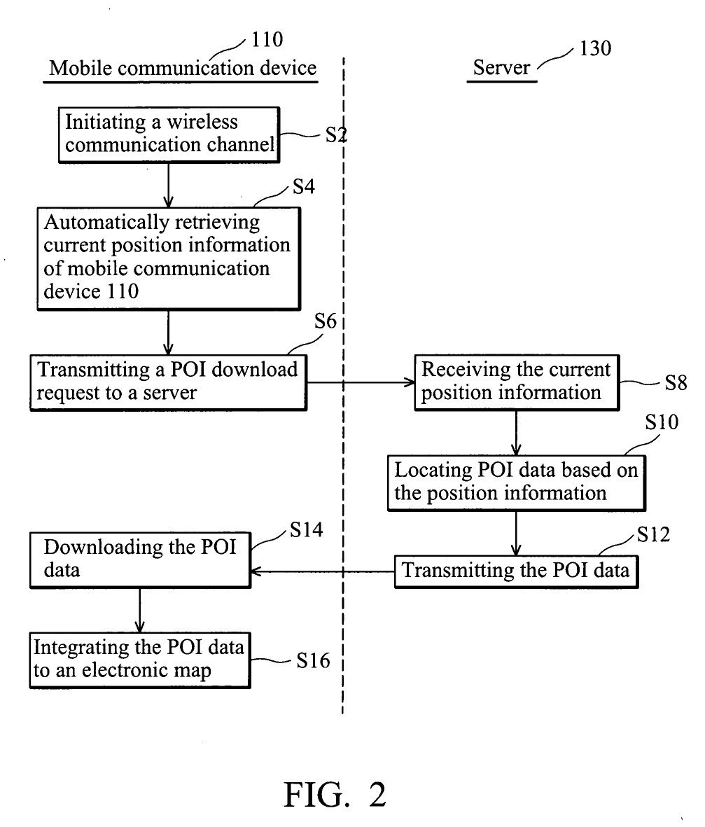

With reference to FIG. 2, communication unit 2 initiates wireless communication channel 140 (step S2). Processor 1 may receive from input device 4 a signal for transmitting a POI download request. When receiving the signal, processor 1 automatically retrieves position information indicating the current position of mobile communication device 110, such as current coordinates thereof received from GPS receiver 6 (step S4). Next, processor 1 transmits the POI download request comprising the position information (such as the coordinates) to server 130 through wireless communication channel 140 (step S6). Server 130 receives the position information (such as the coordinates) of mobile communication device 110 (step S8), locates POI data 131 based on the position information (step S10), and transmits POI data 131 to mobile communication device 110 through wireless communication channel 140 (step S12). Mobile communication device 110 downloads POI data 131 from server 130 through wireless communication channel 140 (step S14) and integrates POI data 131 to electronic map 31 (step S16).

Techniques of GPS data transmission are well known in the art, thus, detailed description thereof is omitted.

Although mobile communication device 110 actively issues its GPS coordinates for a POI download, server 130 may locate POI data based on other position information of mobile communication device 110 and actively or passively transmit the POI data thereto.

With reference to FIG. 1, base station 142 is coupled to router 141 and network 120. For example, server 143 identifies the location of mobile communication device 110 by determining which base station covers mobile communication device 110, treats the located base station (base station 142) as the position information, and locates POI data according to the position information.

For example, when mobile communication device 110 roams to the coverage of base station 142, server 143 automatically delivers position information of mobile communication device 110 to server 130 to request POI data. Server 130 locates POI data based on the identification of base station 142. As shown in FIG. 1, the POI data may be stored in advance on servers 130 and 143, or distributed on network 120.

Mobile communication device 110 may search servers that provide POI data in their wireless communication range (utilizing Bluetooth or Wi-Fi techniques) without delivering position information.

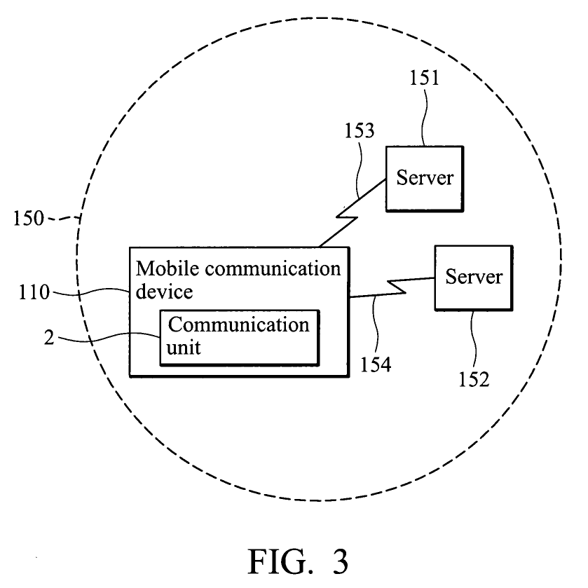

For example, mobile communication device 110 in FIG. 3 initiates a wireless communication channel (which may conform to Bluetooth protocol) within wireless communication range 150 utilizing communication unit 2. Processor 1 automatically determines if wireless communication range 150 comprises a server providing POI data. If wireless communication range 150 comprises servers (such as servers 151 and 152) providing POI data, processor 1 utilizes communication unit 2 to initiate a wireless communication channel (such as channel 153 and 154) thereto and downloads POI data therefrom.

In addition to the POI update function, note that POI data may comprise other information for user's convenience, which is described in the following.

POI data 131 comprises version information 132, time limits 133, and point P. Processor 1 may determine whether to receive a POI data record based on the version information 132. For example, processor 1 determines if version information 132 is newer than the current version of electronic map 31. If so, processor 1 downloads the POI data. If not, processor 1 stops downloading POI data. POI P comprises coordinates 134, POI name 135, POI type 135A, POI address 136, local guide (map) 137, commodity catalog 138. POI type 135A may be one of various types (such as restaurants, clothing, hotels, education, and entertainments) and comprise attributes (such as suitable age levels and suitable gender) of the POI. POI spread throughout a current electronic map typically appear as simplified points or blocks, but the geography therein is not presented. Thus, a local guide 137 may comprise the interior geography of a certain place in an image format. When point P has been integrated into electronic map 31 and then selected, processor 1 retrieves and displays local guide (map) 137 and commodity catalog 138 of point P on display 5. Commodity catalog 138 may comprise options (such as radio buttons or checkboxes) for subscribing or ordering trade articles or services.

When displayed on mobile communication device 110, commodity catalog 138 receives subscriptions or orders for trade articles or services from input device 4. Processor 1 then transmits the subscriptions or the orders to respective servers corresponding to the trade articles.

Thus, users can browse trade articles provided at respective points and accordingly subscribe or order utilizing commodity catalog 138.

Processor 1 may configure part POI data of point P, such as commodity catalog 138 to be automatically deleted if not read for a predetermined period of time, thus, the size of POI P is reduced. Additionally, a time limit 133 may comply with a sale time, a movie show time or an exhibition period. Processor 1 may delete portions of POI data 131 based on time limits 133.

POI data 131 may comprise more information, such as advertisement, and may be transmitted in forms of simplified messages or other formats. Processor 1 may filter POI data based on receiving rules 33. For example, receiving rules 33 may comprise restricted POI types. If a POI data record does not match the restricted POI types, processor 1 does not receive the same record.

A large amount of POI data is difficult to download due to bandwidth restrictions, and actually may not fit individual user requirements. Thus, the described receiving rules and the position-based POI data download functions can be customized with local POI data.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile communication device for dynamic update of points of interest, comprising:
a communication unit capable of wireless communication within a range; and
a processor coupled to the communication unit, automatically determining if a server offering points of interest (POI) data exists in the range, and, if so, initiating a wireless communication channel to the server utilizing the communication unit and downloading the POI data therefrom.

2. The device as claimed in claim 1, wherein the POI comprises version data, the processor further determines whether to accept the POI data based on the version data.

3. The device as claimed in claim 1, further comprising: a storage device storing an electronic map to which the POI data is integrated by the processor.

4. The device as claimed in claim 3, wherein the POI data comprises a point and a commodity catalog associated thereto.

5. The device as claimed in claim 3, wherein, when displayed on the mobile communication device, the commodity catalog receives a subscription or an order for a trade article, and the processor transmits the subscription or the order to a server corresponding to the trade article.

6. The device as claimed in claim 3, wherein the processor filters the POI data based on a receiving rule.

7. A mobile communication device for dynamic update of points of interest, comprising:
a communication unit capable of initiating a wireless communication channel;
a global positioning system (GPS) receiver; and
a processor coupled to the communication unit and the GPS receiver, prior to transmitting a request for downloading data of points of interest (POI), automatically retrieving coordinates of the mobile communication device from the GPS receiver, transmitting the request comprising the coordinates through the wireless communication channel to a server, and downloading the POI data therefrom.

8. The device as claimed in claim 7, wherein the POI comprises version data, the processor further determines whether to accept the POI data based on the version data.

9. The device as claimed in claim 7, further comprising: a storage device storing an electronic map to which the POI data is integrated by the processor.

10. The device as claimed in claim 9, wherein the POI data comprises a point and a commodity catalog associated thereto.

11. The device as claimed in claim 10, wherein, when displayed on the mobile communication device, the commodity catalog receives a subscription or an order for a trade article, and the processor transfers the subscription or the order to a server corresponding to the trade article.

12. The device as claimed in claim 7, wherein the processor filters the POI data based on a receiving rule.

13. A system for dynamic update of points of interest, comprising:
a mobile communication device comprising an electronic map and initiating a wireless communication channel; and
a server coupled to the mobile communication device through the wireless communication channel, determining the current position of the mobile communication device, locating points of interest (POI) data based on the position, and transmitting the POI data to the mobile communication device through the wireless communication channel, wherein the mobile communication device receives and integrates the POI data into the electronic map.

14. The system as claimed in claim 13, wherein the mobile communication device transmits a request for downloading the POI data to the server, the request comprises global positioning system (GPS) coordinates of the mobile communication device indicating the current position, and the server determines the current position of the mobile communication device based on the GPS coordinates.

15. A The system as claimed in claim 13, wherein the server determines the current position of the mobile communication device utilizing base stations covering the mobile communication device, and locates the POI data accordingly.

16. The system as claimed in claim 13, wherein the POI comprises version data, the processor further determines whether to accept the POI based on the version data.

17. The system as claimed in claim 13, wherein the POI data comprises a point and a commodity catalog associated therewith.

18. The system as claimed in claim 13, wherein, when displayed on the mobile communication device, the commodity catalog receives a subscription or an order for a trade article, and the mobile communication device transmits the subscription or the order to a server corresponding to the trade article.

19. The system as claimed in claim 13, wherein the mobile communication device filters the POI data based on a receiving rule.
